(19) United States
(12) Patent Application Publication
(10) Pub. No.: US 2015/0171622 A1
(43) Pub. Date: Jun. 18, 2015

(54) INTEGRATED SURGE-ABSORBING DEVICE

(71) Applicant: POWERTECH INDUSTRIAL CO., LTD., NEW TAIPEI CITY (TW)

(72) Inventors: YU-LUNG LEE, NEW TAIPEI CITY (TW); TUN-CHI YU, TAIPEI CITY (TW)

(21) Appl. No.: 14/274,781

(22) Filed: May 12, 2014

(30) Foreign Application Priority Data
Dec. 13, 2013 (TW) 102146141

(51) Int. Cl. H02H 9/00; H02H 9/02

(52) U.S. Cl. CPC H02H 9/001; H02H 9/02

(57) ABSTRACT

An integrated surge-absorbing device includes a surge-absorbing unit and a first external lead structure. The surge-absorbing unit includes a plurality of varistors stacked with together and a first metal lead, which is disposed between two of the neighboring varistors and has a first end protruding toward a first side edge of the varistors. A first end of the conductive rod of the first external lead structure is connecting to the first end of the first lead through a first low-melting-point metallic material. The first external lead structure applies a first resilient force to the first conductive rod.

### BACKGROUND OF THE INVENTION

1. Field of the Invention

The instant disclosure relates to a surge-absorbing device; in particular, to an integrated surge-absorbing device having at least two varistors.

2. Description of Related Art

When a varistor releases the surge energy in the manner of heat, the temperature of the varistor might rise. In prior art, the thermal protection mechanism is designed for single varistor. For example, the U.S. Patent Publication No. 2009027153 discloses that a thermal cutoff fuse is electrically cascaded between a conductive pin of a varistor and a main body of the varistor. The U.S. Pat. No. 8,279,575 discloses a surge suppressor with a thermal protection device which is designed for single varistor. The thermal protection device is positioned on the backside of the surge suppressor, in which the backside area of the surge suppressor is utilized to form a space allowing a quenching element to move.

In addition, the Patent Publication No. TW201327587 discloses a protection device with thermal guiding function. Similarly, the protection device is designed for single varistor. Moreover, since a thermal guiding portion of the protection device is an extension of an electrode electrically connected to the surface of the main body and extends outward from the surface of the main body, so as to match an external thermal protection device disposed outside of a sealing of epoxy resin material.

### SUMMARY OF THE INVENTION

The present disclosure provides an integrated surge-absorbing device, which includes a surge-absorbing unit and a first external lead structure. The surge-absorbing unit includes a first varistor and a second varistor arranged together with the first varistor in a stack. A first lead is disposed between the first varistor and the second varistor. A first end of the first lead protrudes toward a first side of the surge-absorbing unit. The first external lead structure is positioned on the first side of the surge-absorbing unit. The first external lead structure includes a first conductive rod. A first end of the first conductive rod is electrically connected to the first end of the first lead through a first low-melting-point metallic material. The first external lead structure applies a first resilient force to the first conductive rod. Thereby the first external lead structure cuts off the connection between the first conductive rod and the first lead when the first low-melting-point metallic material melts.

In order to further understand the instant disclosure, the following embodiments and illustrations are provided. However, the detailed description and drawings are merely illustrative of the disclosure, rather than limiting the scope being defined by the appended claims and equivalents thereof.

### BRIEF DESCRIPTION OF THE DRAWINGS

FIG. 1 is an appearance view of an integrated surge-absorbing device in accordance with a first embodiment of the instant disclosure.

FIG. 2A and FIG. 2B are perspective views of the integrated surge-absorbing device in accordance with a first embodiment of the instant disclosure.

FIG. 3 is a perspective view of the integrated surge-absorbing device in accordance with a first embodiment of the instant disclosure.

FIG. 4A is a perspective view of a surge-absorbing unit of the integrated surge-absorbing device in accordance with the first embodiment of the instant disclosure.

FIG. 4B and FIG. 4C are side views of the surge-absorbing unit of the integrated surge-absorbing device in accordance with the first embodiment of the instant disclosure.

FIG. 5A and FIG. 5B are perspective views of the integrated surge-absorbing device in accordance with a second embodiment of the instant disclosure.

FIG. 6 is a perspective view of the integrated surge-absorbing device in accordance with the second embodiment of the instant disclosure.

FIG. 7 is a perspective view of the integrated surge-absorbing device in accordance with a third embodiment of the instant disclosure.

FIG. 8 is a perspective view of the integrated surge-absorbing device in accordance with the third embodiment of the instant disclosure.

FIG. 9 is a perspective view of the integrated surge-absorbing device in accordance with a forth embodiment of the instant disclosure.

FIG. 10 is a perspective view of the integrated surge-absorbing device in accordance with a fifth embodiment of the instant disclosure.

### DETAILED DESCRIPTION OF THE PREFERRED EMBODIMENTS

### The First Embodiment of the Instant Disclosure

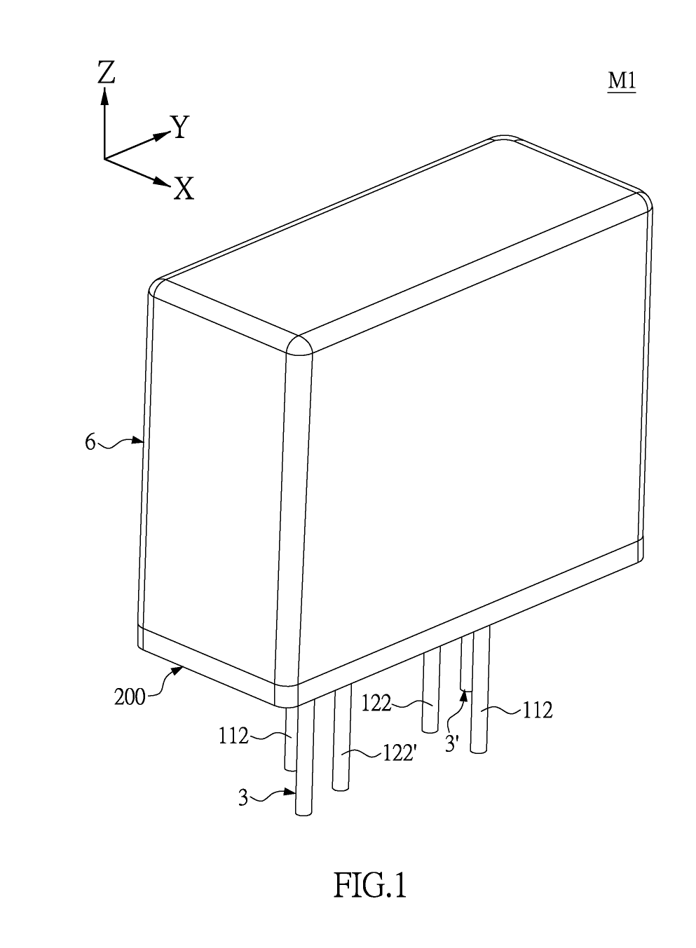

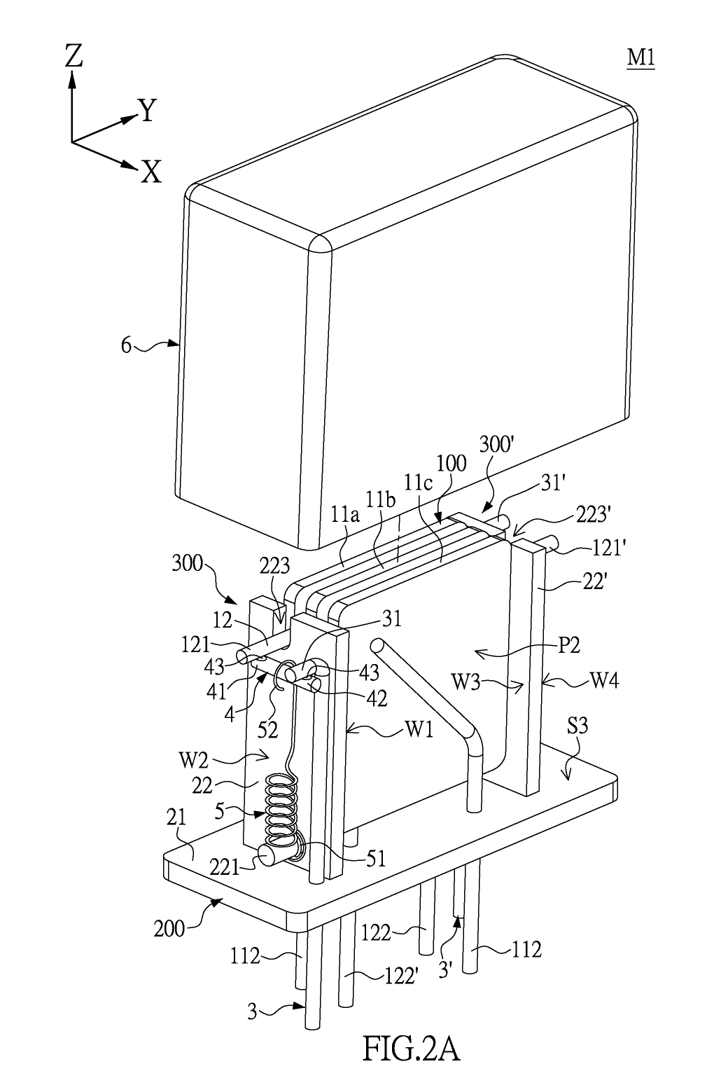

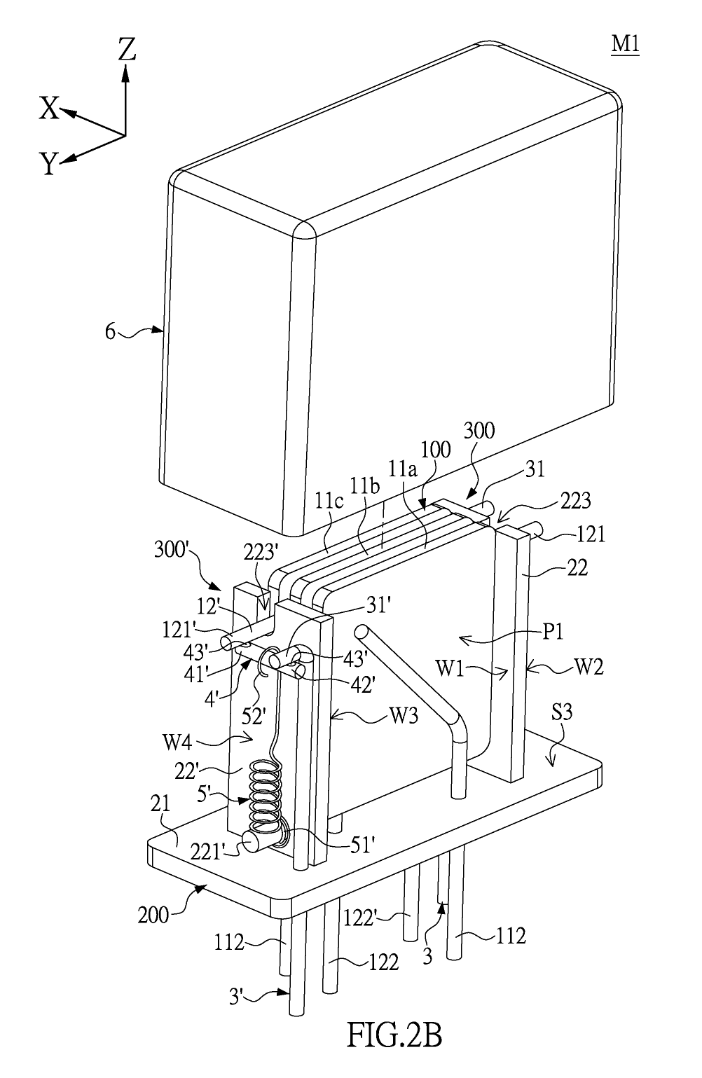

Referring to FIG. 1, FIG. 2A, and FIG. 2B, the integrated surge-absorbing device M1 includes a surge-absorbing unit 100, a carrier 200, a first external lead structure 300 disposed on a first side of the surge-absorbing unit 100, and a second external lead structure 300′ disposed on a second side of the surge-absorbing unit 100.

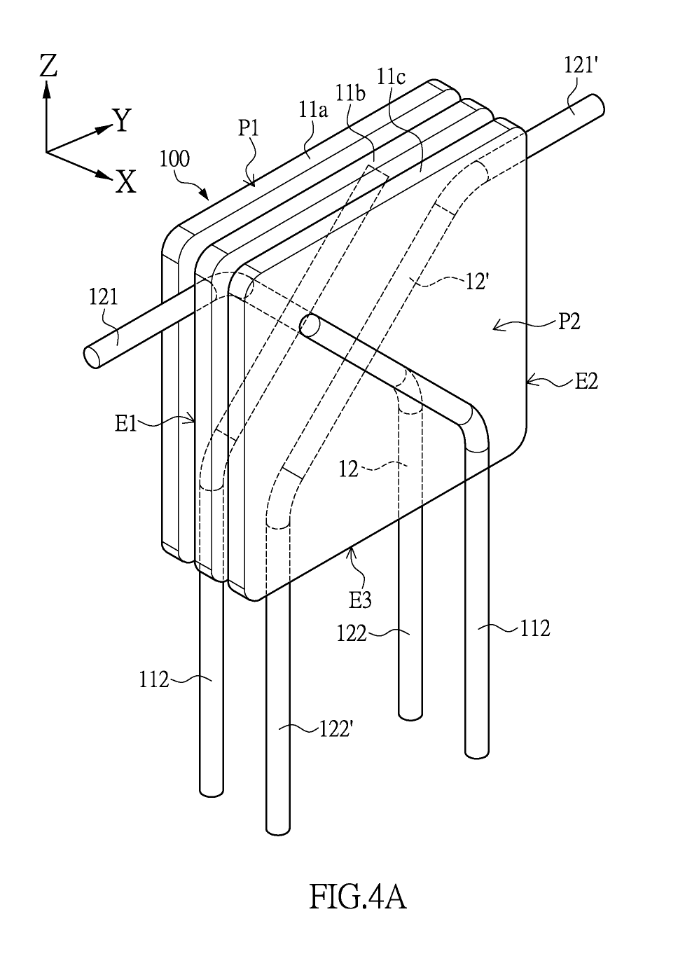

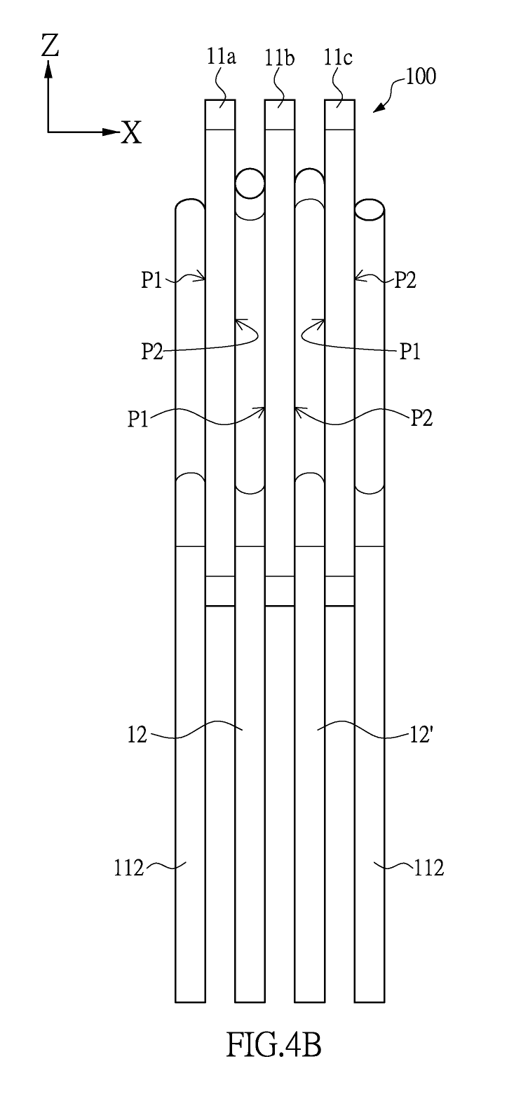

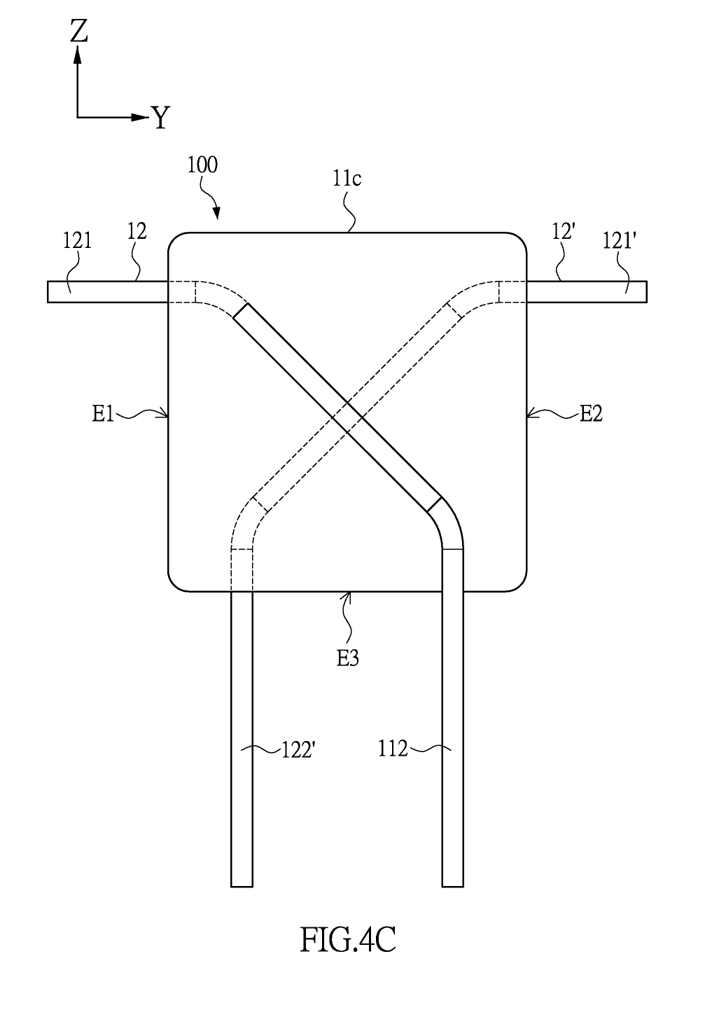

Referring to FIG. 4A, FIG. 4B, and FIG. 4C, the surge-absorbing unit 100 includes a first varistor 11a, a second varistor 11b, and a third varistor 11c. Three varistor 11a, 11b, and 11c are arranged all together in a stack. Varistors 11a, 11b, and 11c each include a first electrode face P1 and a second electrode face P2. In addition, the stack of the varistors 11a, 11b, and 11c includes a first side edge E1 and a second side edge E2 opposite to the first side edge E1. A lower edge E3 of the stack of the varistors 11a, 11b, and 11c is connected between the first side edges E1 and the second side edges E2. The first side of the surge-absorbing unit 100 corresponds to the first side edge E1 and the second side of the surge-absorbing unit 100 corresponds to the second side edge E2.

A first lead 12 is disposed between the first varistor 11a and the second varistor 11b, and a second lead 12′ is disposed between the second varistor 11b and the third varistor 11c. A first end 121 of the first lead 12 protrudes toward the first side of the surge-absorbing unit 100 and projects from the first side edge E1 of the varistors 11a, 11b, and 11c. A second end 122 of the first lead 12 protrudes from the lower edge E3 of the varistors 11a, 11b, and 11c. A first end 121′ of the second lead 12′ protrudes toward the second side of the surge-absorbing unit 100 and projects from the second side edge E2 of the varistors 11a, 11b, and 11c. A second end 122′ of the second lead 12′ protrudes from the lower edge E3 of the varistors 11a, 11b, and 11c. The first lead 12 and the second lead 12′ are made of conductive material.

The surge-absorbing unit 100 further includes a plurality of conductive pins 112. One end of each of the conductive pins 112 is soldered to the first electrode face P1 or the second electrode face P2 of the varistors 11a, 11b, and 11c. The other end of each of the conductive pins 112 protrudes from the lower edge E3 of the varistors 11a, 11b, and 11c, so as to be electrically connected to an external circuit (not show in the figures). The conductive pins 112, for example, are tinned copper wires.

The carrier 200 is utilized to carry the surge-absorbing unit 100. The carrier 200, for example, is made of insulating material. Referring to FIG. 2A and FIG. 2B, the carrier 200 includes a substrate 21 and the surge-absorbing unit 100 is disposed on the substrate 21. The carrier 200 further includes a first insulating wall 22 and a second insulating wall 22′. The insulating walls 22 and 22′, for example, are ceramic plates and protrude from an upper surface S3 of the substrate 21.

The first insulating wall 22 is disposed between the surge-absorbing unit 100 and the first external lead structure 300, and the second insulating wall 22′ is disposed between the surge-absorbing unit 100 and the second external lead structure 300′. Specifically, the surge-absorbing unit 100 is disposed on an inner side of the first insulating wall 22. The first end 121 of the first lead 12 penetrates through the first insulating wall 22 and protrudes from an outer side of the first insulating wall 22. The first external lead structure 300 is disposed on the outer side of the first insulating wall 22. In addition, the surge-absorbing unit 100 is disposed on an inner side of the second insulating wall 22′. The first end 121′ of the second lead 12′ penetrates through the second insulating wall 22′ and protrudes from an outer side of the second insulating wall 22′. The second external lead structure 300′ is disposed on the outer side of the second insulating wall 22′.

As shown in the figures, the first end 121 of the first lead 12 extends through a first opening 223 on the upper edge of the first insulating wall 22 and is disposed on the first insulating wall 22. The first end 121′ of the second lead 12′ extends through a second opening 223′ on the upper edge of the second insulating wall 22′ and is disposed on the second insulating wall 22′.

Therefore, the first external lead structure 300 is separated from the varistors 11a, 11b, and 11c in the structure space by the first insulating wall 22, and the second external lead structure 300′ is separated from the varistors 11a, 11b, and 11c in the structure space by the second insulating wall 22′. In another embodiment, the carrier 2 might only include the first insulating wall 22, or only include the insulating wall 22′. The integrated surge-absorbing device M1 might not have the carrier 200.

The first external lead structure 300 includes a first conductive rod 4. A first end 41 of the first conductive rod 4 is electrically connected to the first end 121 of the first lead 12 through a first low-melting-point metallic material 43. In addition, the first external lead structure 300 applies a first resilient force to the first end 41 of the first conductive rod 4, so as to cut off the connection between the first conductive rod 4 and the first lead 12 when the first low-melting-point metallic material 43 melts.

In the present embodiment, the first external lead structure 300 further includes a first power pin 3 and a first resilient element 5. As shown in FIG. 2A, the height of a first end 31 of the first power pin 3 and the height of the first end 121 of the first lead 12 are roughly the same. A second end 32 of the first power pin 3 protrudes from the substrate 21, so as to connect to the external circuit. The first power pin 3, for example, is a tinned copper wire.

The first end 41 and a second end 42 of the first conductive rod 4 are respectively electrically connected to the first end 121 of the first lead 12 and the first end 31 of the first power pin 3 through the first low-melting-point metallic material 43. The melting point of the first low-melting-point metallic material 43 might be, for example, lower than the ignition temperature of the varistors 11a, 11b, and 11c. The melting point of the first low-melting-point metallic material 43 might be in the range of 80 to 140 degrees centigrade. For example, the melting point of the first low-melting-point metallic material 43 can be in the range of 80 to 100 degrees centigrade, in the range of 100 to 140 degrees centigrade, or in the range of 110 to 125 degrees centigrade. In an exemplary embodiment, the melting point of the first low-melting-point metallic material 43 is 115 degrees centigrade.

The first low-melting-point metallic material 43 might be an alloy and include aluminum, silver, lead, antimony, zinc, tin, bismuth, indium, cadmium, magnesium, or any combination of the above-mentioned materials. It's worth noting that, the first conductive rod 4 connected between the first lead 12 and the first power pin 3 is disposed beneath the first end 121 of the first lead 12 and the first end 31 of the first power pin 2.

A first end 51 of the first resilient element 5 might hitch to a first fixing part 221 at the bottom of an outer face W2 of the first insulating wall 22, so as to be fixed on the carrier 2. A second end 52 of the first resilient element 5, for example, might hang on the first conductive rod 4, whereby the second end 52 is connected to the first conductive rod 4. The first resilient element 5, for example, might be a linear spring or a rubber band. When the first conductive rod 4 is connected to the first lead 12 and the first power pin 3 through soldering by the first low-melting-point metallic material 43, the first resilient element 5 has a deformation, so as to apply the first resilient force to the first conductive rod 4 to pull down the first conductive rod 4.

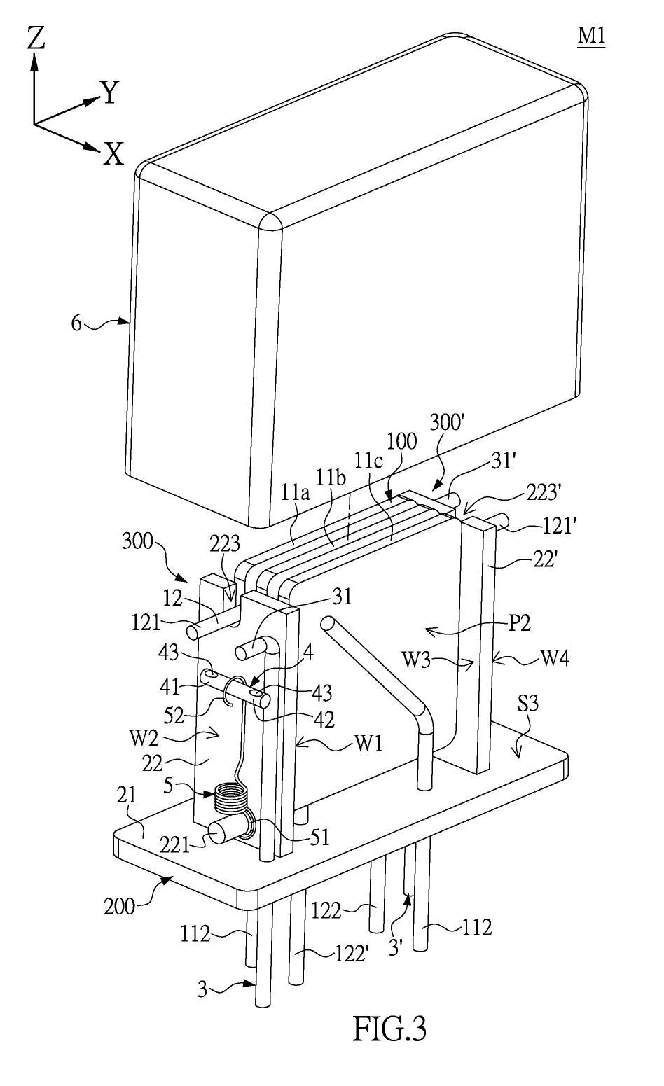

Referring to FIG. 2A and FIG. 3, in the process of releasing the surge energy in the manner of heat, the heat can be transferred from the varistors 11a and 11b to the first low-melting-point metallic material 43 through the first lead 12 precisely and immediately. When the temperature of the first lead 12 rises and the first low-melting-point metallic material 43 melts, the first external lead structure 300 cuts off the connection between the first conductive rod 4 and the first end 121 of the first lead 12 through the first resilient element 5, thereby cutting off the electrical connection of the surge-absorbing unit 100. Moreover, when the temperature of the first conductive rod 4 rises by the heat conduction and the first low-melting-point metallic material 43 melts, the first external lead structure 300 might also cut off the connection between the first conductive rod 4 and the first end 31 of the first power pin 3 by the first resilient element 5. Therefore, before the thermal breakdown occurs, the surge-absorbing unit 100 of present embodiment can become electrical disconnected.

In another embodiment, when the temperature of the first conductive rod 4 rises and the first low-melting-point metallic material 43 melts, the first external lead structure 300 might only cut off the connection between the first conductive rod 4 and the first lead 12, instead of cutting off the connection between the first conductive rod 4 and the first power pin 3, in which the first external lead structure 300 can still cut off the electrical connection between the first lead 12 and the first power pin 3. Or, the first external lead structure 300 might only cut off the connection between the first conductive rod 4 and the first power pin 3, instead of cutting off the connection between the first conductive rod 4 and the first lead 12.

Moreover, when the first conductive rod 4 is pulled down and separated from the first lead 12 and the first power pin 3, the first resilient element 5 and the first conductive rod 4 are retained on the outer side of the first insulating wall 22, in which the interference to the surge-absorbing unit 100 during the operation of the first external lead structure 300 can be avoid.

Referring to FIG. 2B, the second external lead structure 300′ on the second side of the surge-absorbing unit 100, a second conductive rod 4′, a first end 41′ of the second conductive rod 4′, the operation of each element, and the connection between the elements are similar to the elements on the first side of the surge-absorbing unit 100 in FIG. 2A, further descriptions are hereby omitted. The melting temperature of a second low-melting-point metallic material 43′ might be the same as or different from the melting temperature of the first low-melting-point metallic material 43.

In addition, the integrated surge-absorbing device M1 further includes an insulating cover 6 covering on the carrier 200. When the first conductive rod 4 is separated from the first lead 12 or the first power pin 3, the first resilient element 5 and the first conductive rod 4 can be retained on the outer side of the first insulating wall 22 and inside the insulating cover 6 to avoid the electrical interference. However, the insulating cover 6, the carrier 200, or the insulating walls 22 and 22′ might be omitted according to need. In another embodiment, the surge-absorbing unit 100 can be sealed directly.

The above mentioned elements and the relative positions thereof can be modified according to need. The following paragraphs describe other embodiments of the integrated surge-absorbing device in the present disclosure. It's worth noting that, other features of the elements not mentioned in the following embodiments can be the same as the previous embodiment.

### The Second Embodiment of the Instant Disclosure

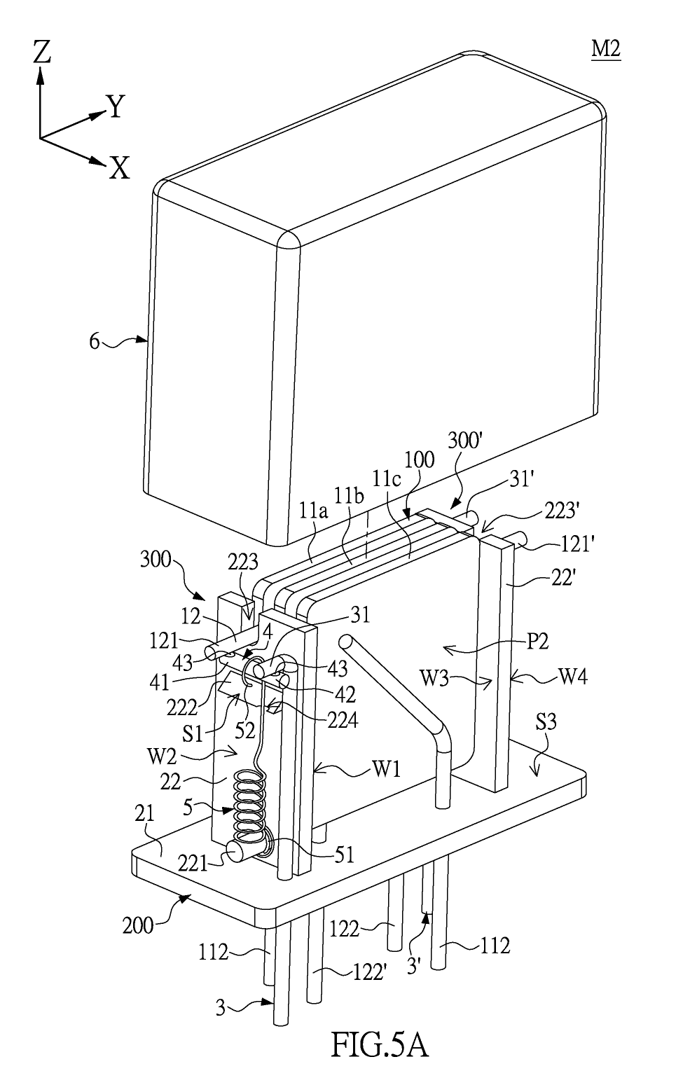

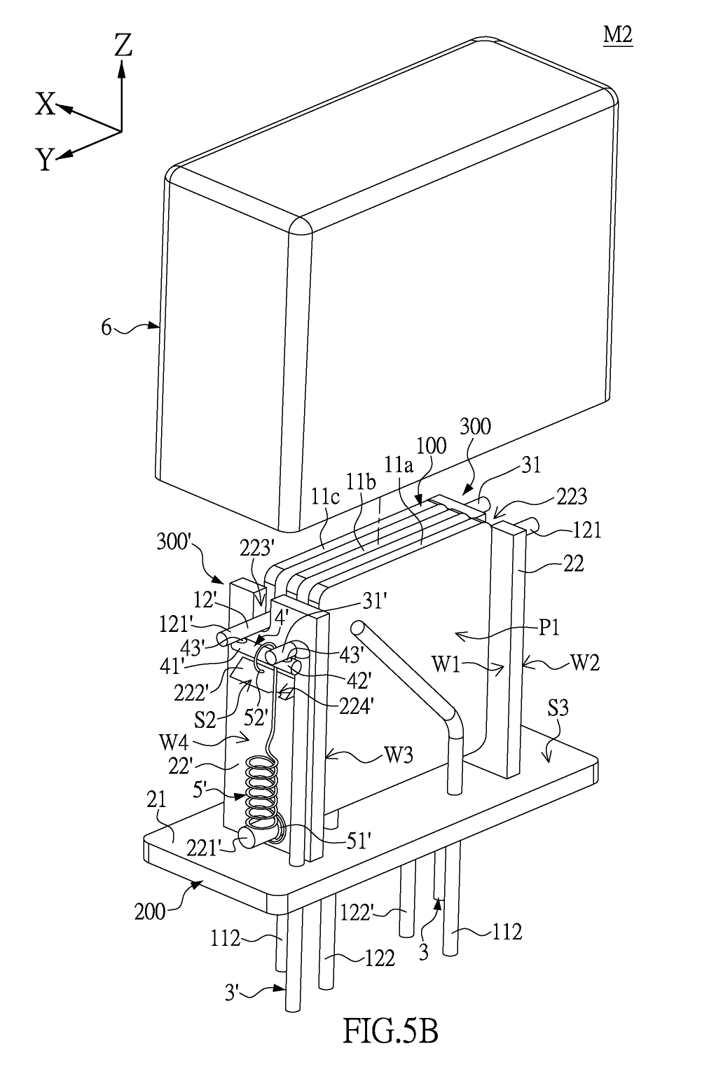

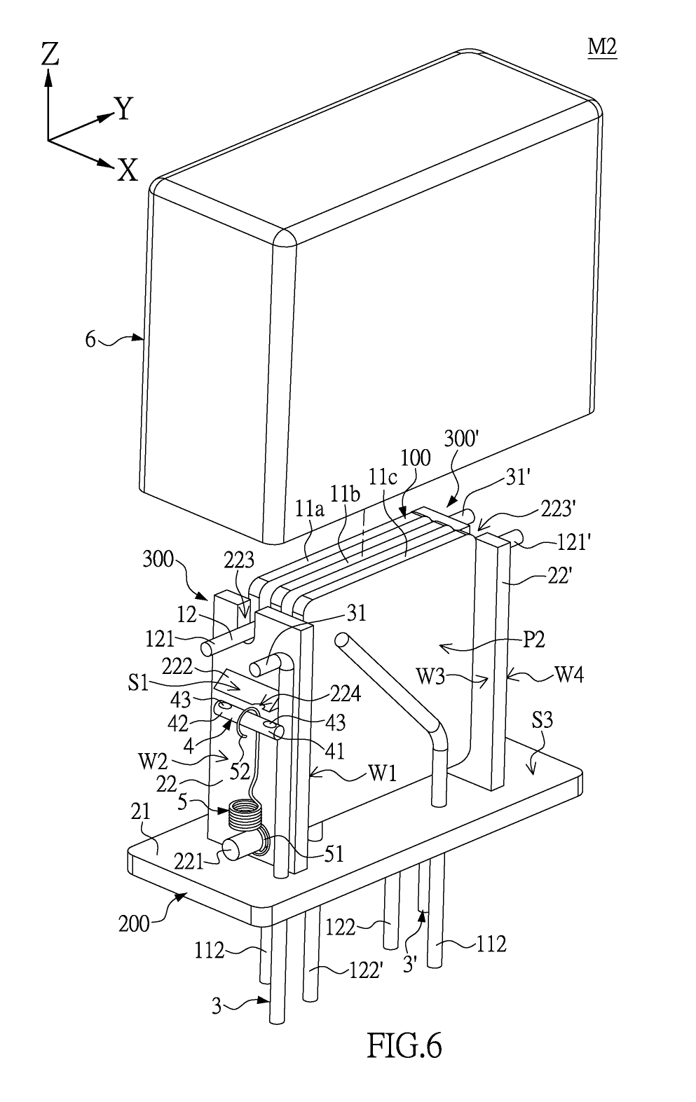

Referring to FIG. 5A, FIG. 5B, and FIG. 6, the first insulating wall 22 has a first position-limiting projection 222 disposed on the outer face W2. The first conductive rod 4 is disposed above the first position-limiting projection 222. The first end 51 of the first resilient element 5 is disposed below the first position-limiting projection 222.

As shown in FIG. 6, after the first conductive rod 4 is separated from the first lead 12 and the first power pin 3 and pulled down below the first position-limiting projection 222, the first position-limiting projection 222 can retain the first conductive rod 4 below the first position-limiting projection 222. In addition, because of the slope of the upper wall S1 of the first position-limiting projection 222, the first position-limiting projection 222 does not hinder the downward movement of the first conductive rod 4. The lower side edge of the upper wall S1 further has a first recess 224. Because of the design of the first recess 224, the first position-limiting projection 222 does not hinder the deformation of the first resilient element 5.

Referring to FIG. 5B, the second insulating wall 22′ has a second position-limiting projection 222′ disposed on an outer face W4 of the second insulating wall 22′. The detailed features of the second position-limiting projection 222′ are similar to the first position-limiting projection 222.

### The Third Embodiment of the Instant Disclosure

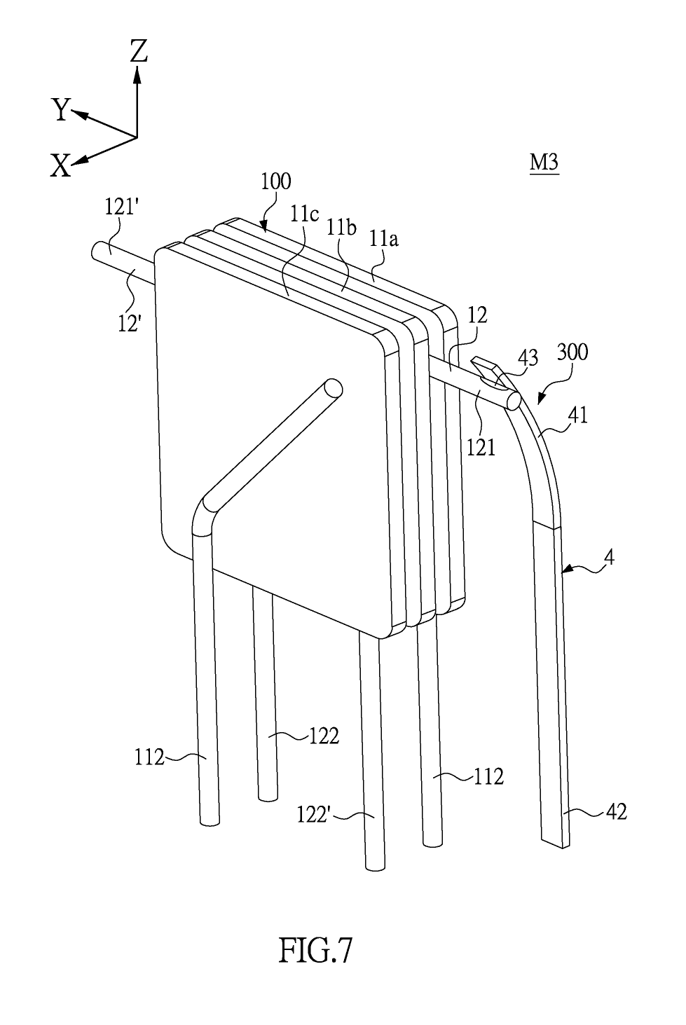

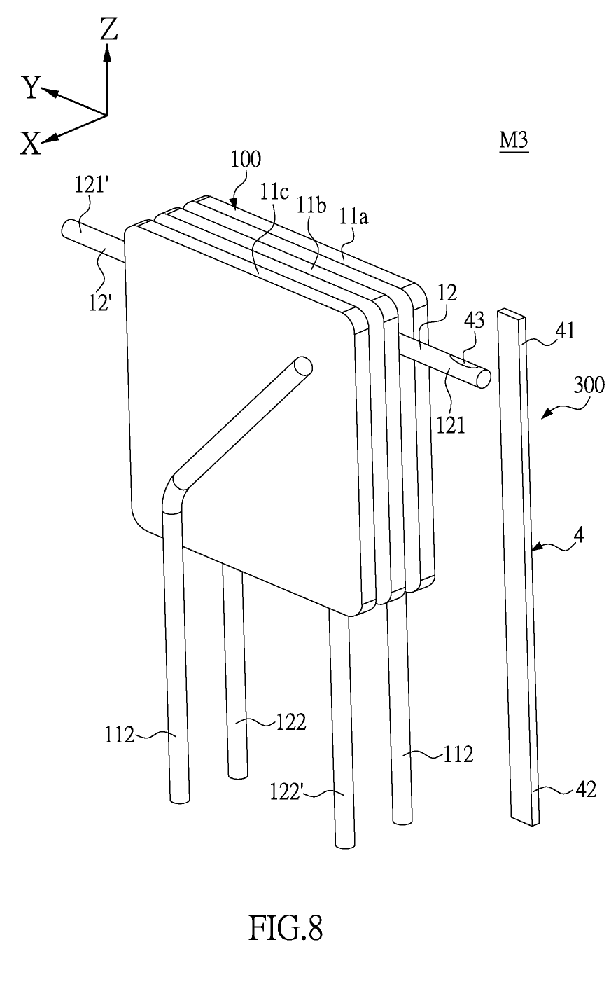

As shown in FIG. 7 and FIG. 8, the first external lead structure 300 in the present embodiment doesn't includes the first power pin 3 and the first resilient element 5 (as shown in FIG. 2A). The first conductive rod 4, for example, is a deformable plate made of conductive material. The second end 42 of the first conductive rod 4 extends outward to connect to the external circuit (not shown in the figures). When the first conductive rod 4 is connected to the first end 121 of the first lead 12 through the first low-melting-point metallic material 43, the first conductive rod 4 has a first deformation, so as to generate the first resilient force. Thereby the first end 41 of the first conductive rod 4 flips away from the first end 121 of the first lead 12 when the first low-melting-point metallic material 43 melts.

In addition, the integrated surge-absorbing device M3 further includes the second external lead structure 300′ (not shown in the figures) disposed on the second side of the surge-absorbing unit 100. The detailed features of the second external lead structure 300′ are similar to the first external lead structure 300.

### The Forth Embodiment of the Instant Disclosure

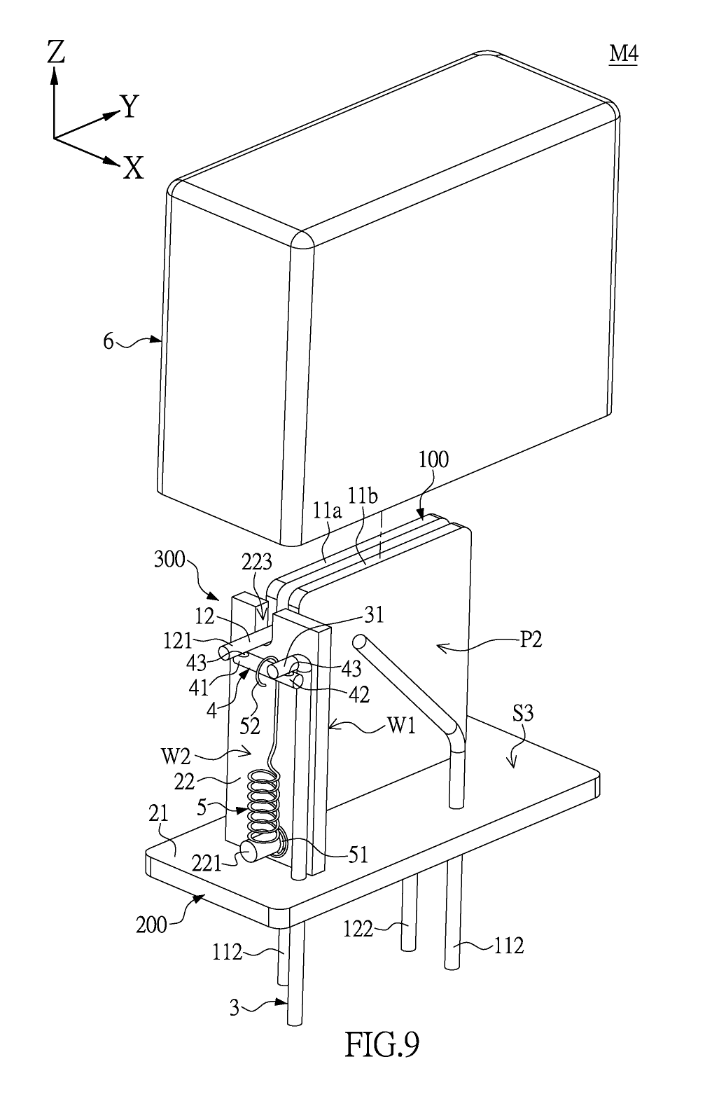

As shown in FIG. 9, the integrated surge-absorbing device M4 in the present embodiment doesn't include the second external lead structure 300′ (as referred in FIG. 2B). The surge-absorbing unit 100 only includes the varistor 11a and varistor 11b arranged together in a stack.

### The Fifth Embodiment of the Instant Disclosure

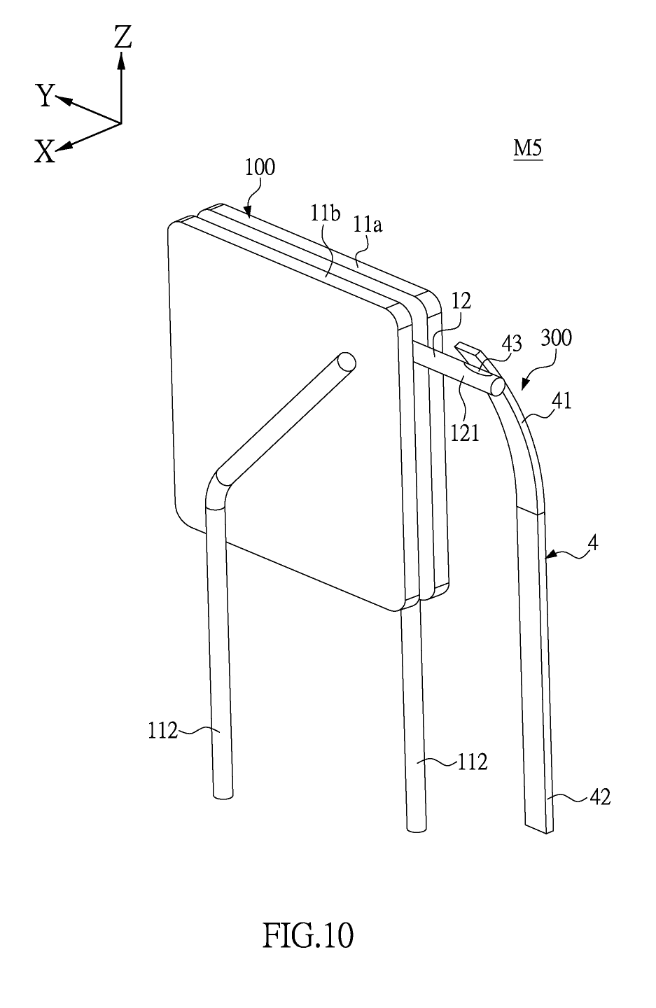

As shown in FIG. 10, different from the integrated surge-absorbing device M3 of the previous embodiment, the integrated surge-absorbing device M5 in the present embodiment doesn't include the second external lead structure 300′ (as shown in FIG. 2B). The surge-absorbing unit 100 only includes two varistors 11a and 11b arranged together in a stack.

In accordance with the instant embodiment, the first lead 12 is utilized as a temperature sensing pin to transfer the heat from the varistors 11a, 11b, and 11c, and as an electrically conductive pin. In the structural arrangement of the integrated surge-absorbing device M1˜M5, the first external lead structure 300 electrically connected to the first lead 12 is disposed on the first side of the surge-absorbing unit 100. The design might make full use of the structural space, especially in the application for the stack of the varistors 11a, 11b, and 11c, and avoid the increase in the overall thickness of the device.

In an exemplary embodiment of the present disclosure, lizes the second lead 12′ is utilized as another temperature sensing pin and as an electrically conductive pin. The above-mentioned integrated surge-absorbing device M1˜M3 can have two thermal cut-off mechanism through the first external lead structure 300 and the second external lead structure 300′ respectively disposed on the two side of the surge-absorbing unit 100. On the premise of avoiding an increase in the overall thickness of the device, the above-mentioned integrated surge-absorbing device M1˜M3 can utilize the two thermal cut-off mechanisms, which are individually actuated and under different temperature conditions, so as to double prevent the varistors from continuously heating.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. An integrated surge-absorbing device, comprising:
a surge-absorbing unit, comprising a first varistor and a second varistor arranged together in a stack, wherein a first lead is disposed between the first varistor and the second varistor, and a first end of the first lead protrudes toward a first side of the surge-absorbing unit; and
a first external lead structure, disposed on the first side of the surge-absorbing unit and comprises a first conductive rod, wherein a first end of the first conductive rod is electrically connected to the first end of the first lead through a first low-melting-point metallic material, and the first external lead structure applies a first resilient force to the first conductive rod;
wherein the first external lead structure cuts off the connection between the first conductive rod and the first lead when the first low-melting-point metallic material melts.

2. The integrated surge-absorbing device of claim 1, wherein the first external lead structure comprises a first power pin, the first power pin has a first end, the first end of the first conductive rod and a second end of the first conductive rod are respectively electrically connected to the first end of the first lead and the first end of the first power pin through the first low-melting-point metallic material, and the first external lead structure applies the first resilient force to the first conductive rod, wherein the first external lead structure cuts off the connection between the first conductive rod and the first power pin when the first low-melting-point metallic material melts.

3. The integrated surge-absorbing device of claim 1, further comprising a carrier for carrying the surge-absorbing unit, wherein the first external lead structure comprises a first resilient element, a first end of the first resilient element is fixed at the carrier, a second end of the first resilient element is connected to the first conductive rod, and the first external lead structure applies the first resilient force to the first conductive rod through the first resilient element.

4. The integrated surge-absorbing device of claim 3, wherein the carrier further comprises a first insulating wall disposed between the surge-absorbing unit and the first external lead structure, the surge-absorbing unit is disposed on an inner side of the first insulating wall, the first end of the first lead is penetrating through the first insulating wall and protruding from an outer side of the first insulating wall, and the first external lead structure is disposed on the outer side of the first insulating wall.

5. The integrated surge-absorbing device of claim 1, wherein when the first conductive rod is electrically connected to the first lead through the first low-melting-point metallic material, the first conductive rod has a first deformation, so as to generate the first resilient force, wherein the first end of the first conductive rod flips away from the first end of the first lead when the first low-melting-point metallic material melts.

6. An integrated surge-absorbing device, comprising:
a surge-absorbing unit, comprising a first varistor, a second varistor and a third varistor arranged together in a stack, wherein a first lead is disposed between the first varistor and the second varistor, a second lead is disposed between the second varistor and the third varistor, a first end of the first lead is protruding toward a first side of the surge-absorbing unit, and a first end of the second lead is protruding toward a second side of the surge-absorbing unit;
a first external lead structure, disposed on the first side of the surge-absorbing unit and comprising a first conductive rod, wherein a first end of the first conductive rod is electrically connected to the first end of the first lead through a first low-melting-point metallic material, and the first external lead structure applies a first resilient force to the first conductive rod; and
a second external lead structure, disposed on the second side of the surge-absorbing unit, and comprising a second conductive rod, wherein a first end of the second conductive rod is electrically connected to the first end of the second lead through a second low-melting-point metallic material, and the second external lead structure applies a second resilient force to the second conductive rod;
wherein the first external lead structure cuts off the connection between the first conductive rod and the first lead when the first low-melting-point metallic material melts, and the second external lead structure cuts off the connection between the second conductive rod and the second lead when the second low-melting-point metallic material melts.

7. The integrated surge-absorbing device of claim 6, wherein the first external lead structure comprises a first power pin, the first power pin has a first end, the first end of the first conductive rod and a second end of the first conductive rod are respectively electrically connected to the first end of the first lead and the first end of the first power pin through the first low-melting-point metallic material, and the first external lead structure applies the first resilient force to the first conductive rod, wherein the first external lead structure cuts off the connection between the first conductive rod and the first power pin when the first low-melting-point metallic material melts; and the second external lead structure comprises a second power pin, the second power pin has a first end, the first end of the second conductive rod and a second end of the second conductive rod are respectively electrically connected to the first end of the second lead and the first end of the second power pin through the second low-melting-point metallic material, and the second external lead structure applies the second resilient force to the second conductive rod, wherein the second external lead structure cuts off the connection between the second conductive rod and the second power pin when the second low-melting-point metallic material melts.

8. The integrated surge-absorbing device of claim 6, further comprising a carrier for carrying the surge-absorbing unit, wherein the first external lead structure comprises a first resilient element, a first end of the first resilient element is disposed at the carrier, a second end of the first resilient element is connected to the first conductive rod, the first external lead structure applies the first resilient force to the first conductive rod through the first resilient element, the second external lead structure comprises a second resilient element, a first end of the second resilient element is fixed at the carrier, a second end of the second resilient element is connected to the second conductive rod, and the second external lead structure applies the second resilient force to the second conductive rod through the second resilient element.

9. The integrated surge-absorbing device of claim 8, wherein the carrier further comprises a first insulating wall and a second insulating wall, the first insulating wall is disposed between the surge-absorbing unit and the first external lead structure, the surge-absorbing unit is disposed on the inner side of the first insulating wall, the first end of the first lead is penetrating through the first insulating wall and protruding from an outer side of the first insulating wall, the first external lead structure is disposed on the outer side of the first insulating wall, the second insulating wall is disposed between the surge-absorbing unit and the second external lead structure, the surge-absorbing unit is disposed on the inner side of the second insulating wall, the first end of the second lead is penetrating through the second insulating wall and protruding from an outer side of the second insulating wall, and the second external lead structure is disposed on the outer side of the second insulating wall.

10. The integrated surge-absorbing device of claim 6, wherein when the first conductive rod is electrically connected to the first lead through the first low-melting-point metallic material, the first conductive rod has a first deformation, so as to generate the first resilient force, wherein the first end of the first conductive rod flips away from the first end of the first lead when the first low-melting-point metallic material melts; and when the second conductive rod is electrically connected to the second lead through the second low-melting-point metallic material, the second conductive rod has a second deformation, so as to generate the second resilient force, wherein the first end of the second conductive rod flips away from the first end of the second lead when the second low-melting-point metallic material melts.
